(19) United States
(12) Patent Application Publication
(10) Pub. No.: US 2011/0127348 A1
(43) Pub. Date: Jun. 2, 2011

(54) OXYGEN BLOWING LANCE WITH PROTECTION ELEMENT

(76) Inventors: Helmut Kerschbaum, Neuzeug (AT); Stefan Lechner, Leonding (AT); Marinko Lekic-Ninic, Linz (AT); Ewald Reisenberger, Zwettl an der Rodl (AT); Harald Traxinger, Marchtrenk (AT); Peter Wimmer, Linz (AT)

(21) Appl. No.: 12/997,008

(22) PCT Filed: May 25, 2009
(86) PCT No.: PCT/EP2009/056267

§ 371 Date: Jan. 7, 2011

(30) Foreign Application Priority Data
Jun. 17, 2008 (AT) A963/2008

(51) Int. Cl. B05B 17/04

(52) U.S. Cl. 239/13; 239/132

(57) ABSTRACT

An oxygen blowing lance for steel production, the lance having a protection element. The end of a main oxygen tube at the lance head has a cover shell with outlets. An oxygen outlet nozzle is removably and exchangeably fastened to each outlet. The protection element is provided removably and exchangeably at the lance head end of the oxygen blowing lance. An intermediate space is present between the lance head end of the oxygen blowing lance and the protection element. Penetrations are provided in the protection element, the oxygen outlet nozzles passing through the penetrations from the shell outward, and a gap remains between the oxygen outlet nozzle and the protection element. A protective gas line feeds into the intermediate space between the lance head end of the oxygen blowing lance and the protection element. A method for operating the oxygen blowing lance is also described.

The invention relates to an oxygen blowing lance for the production of steel having a protective element and also to a process for operating it.

### BACKGROUND OF THE INVENTION

In converters for the production of steel, oxygen is blown into the crude steel melt via oxygen blowing lances in order to refine it. That end of the oxygen blowing lance which protrudes into the converter and out of which the oxygen flows is referred to as the lance head. During refining, the lance head is subject to high thermal, mechanical and chemical loading, for example by splashes of steel and slag, abrasion by the leaching of slag and the intake of hot surrounding gases. This loading results in wearing of the lance head, which limits the service life of the lance head. The wearing of the edges of the oxygen outlet nozzles of the lance head, in particular, is a factor which limits the service life. The shape of the edges is decisive for the depth to which the flow of oxygen penetrates into the crude steel melt and thus for the penetration thereof and also the decarburization and tap-to-tap times.

It is known from DE3122178A1 to produce the lance head from copper, to weld it onto the steel tubular body of the oxygen blowing lance and to cool it by virtue of cooling water ducts in its interior, which are connected to the cooling water circuit of the tubular body. A protective cap made of heat-resistant material covers the lance head and can be exchanged, as required, independently of the copper lance head. In the case of such a design, time-consuming checking of the weld seams between the blowing lance body and the lance head is necessary. Leakages in the lance head, through which cooling water flows, or at the weld seams, which are caused by wearing of the lance head or of the protective cap, bear the risk of the ingress of water into the converter, which is hazardous to people and parts of the steelworks. The frequent exchange of the protective cap involves the expenditure of human labor and reduces the availability of the oxygen blowing lance.

### OBJECT OF THE INVENTION

It is an object of the present invention to provide an operationally reliable oxygen blowing lance, which is less susceptible to wear, for the production of steel, and also a process for operating it.

### DESCRIPTION OF THE INVENTION

According to the invention, this object is achieved by an oxygen blowing lance for the production of steel having a protective element, comprising an outer lance tube and a main oxygen tube which is arranged within the outer lance tube, wherein a gap which is closed at the lance head and contains one or more coolant ducts is formed between the outer lance tube and the main oxygen tube, wherein the lance head end of the oxygen blowing lance is provided with the protective element, which covers the lance head end of the oxygen blowing lance and is fastened to the oxygen blowing lance such that it can be removed and exchanged, wherein an intermediate space is present between the lance head end of the oxygen blowing lance and the protective element.

Said oxygen blowing lance having a protective element is characterized in that the end of the main oxygen tube at the lance head is provided with a cover shell having one or more outlets, wherein an oxygen outlet nozzle is fastened to each outlet such that it can be removed and exchanged, in that passages, through which the oxygen outlet nozzles are routed from the shell outward, are present in the protective element, wherein said passages are each dimensioned such that a gap remains between the oxygen outlet nozzle and the protective element, in that openings are present in the protective element and in that at least one protective gas line issuing into the intermediate space between the lance head end of the oxygen blowing lance and the protective element is present.

The end of the main oxygen tube at the lance head is provided with a cover shell which covers the entire cross-sectional area of the end. The cover shell has one or more outlets, through which oxygen delivered in the main oxygen tube can flow out. An oxygen outlet nozzle is fastened to each of said outlets such that it can be removed and exchanged, for example by means of a high-temperature-resistant adhesive. A removable and exchangeable fastening method is understood to mean a fastening method in which a first component can be released from a second component without destruction of the second component, and the second component, after the connection to the first component has been released, is again ready to receive a further first component.

In the present case, this means that an oxygen outlet nozzle can be released from the outlet of the cover shell without destruction of the outlet, and the outlet, after the connection to the oxygen outlet nozzle has been released, is again ready to receive an oxygen outlet nozzle. The oxygen outlet nozzle itself may be destroyed when the connection is released. A fastening method of this type has the effect that a worn oxygen outlet nozzle can be exchanged for a new oxygen outlet nozzle, without the cover shell or the outlets thereof being damaged.

The components are preferably fastened by means of a quick-release device, for example a screw thread, a bayonet catch or a plug-type connection, as a result of which the working time required for exchanging worn oxygen outlet nozzles is reduced.

According to a preferred embodiment, the oxygen outlet nozzles are in the form of Laval nozzles. This ensures a high velocity and large expansion of the oxygen as it leaves the oxygen outlet nozzles, as a result of which good penetration of the crude steel melt and also cooling of the oxygen outlet nozzle are achieved.

According to one embodiment, the oxygen outlet nozzles consist of a material which is resistant to thermal, mechanical and chemical wear under operating conditions, for example stainless steel, stainless steel with a ceramic coating, high-temperature-resistant ceramic, oxide ceramic, nonoxide ceramic, such as for example nitride ceramic and carbide ceramic, fiber-reinforced ceramic materials, such as for example sheet ceramic, corundum-mullite ceramics, refractory ceramics, carbide ceramics, or graphite. Examples of nitride ceramics are aluminum nitride, boron nitride, silicon nitride, silicon aluminum oxide nitride and titanium nitride. Examples of carbide ceramics are silicon carbide or boron carbide. By way of example, oxide ceramics may be ceramic materials based on titanium dioxide with or without other oxides, or ceramic materials having a high aluminum oxide content, or ceramic materials based on beryllium oxide, magnesium oxide, zirconium oxide, aluminum titanate, spinel, mullite or titanium oxide.

According to another embodiment, the oxygen outlet nozzles consist of a carrier, which is coated with such a material and is itself produced from another material.

The lance head end of the oxygen blowing lance is provided with a protective element. Said protective element covers the entire cross-sectional area of the lance head end of the oxygen blowing lance. The protective element protects the lance head end of the oxygen blowing lance against wear and thermal loading. It is fastened to the oxygen blowing lance such that it can be removed and exchanged, for example by means of a high-temperature-resistant adhesive. In the present case, this means that a protective element can be released from the oxygen blowing lance without destruction of the oxygen blowing lance, and the oxygen blowing lance, after the connection to the protective element has been released, is again ready to receive a protective element. A fastening method of this type has the effect that a worn protective element can be exchanged without major outlay for a new protective element, without the oxygen blowing lance being damaged. The protective element itself may be destroyed when the connection is released.

The components are preferably fastened by means of a quick-release device, for example a screw thread, a bayonet catch or a plug-type connection, as a result of which the working time required for exchanging worn protective elements is reduced.

The protective element contains at least one protective body made of a material which, under the conditions prevailing during the oxygen blowing process, is resistant to temperature and temperature fluctuations, oxidation and corrosion resulting from gases, liquids and solids. By way of example, this is a refractory material which withstands temperatures of up to 2000° C. or higher without material failure. By way of example, this is a material which, at temperatures of up to 2000° C., withstands temperature fluctuations of up to 25 000 K/min without material failure. Mechanical, thermal and chemical wearing of the protective element during operation is thereby reduced. The material advantageously has a low density so as to minimize the weight of the protective element.

Preferred materials are high-temperature-resistant ceramics, such as for example oxide ceramic, nonoxide ceramic, such as for example nitride ceramic and carbide ceramic, fiber-reinforced ceramic materials, such as for example sheet ceramic, corundum-mullite ceramics, refractory ceramics, carbide ceramics, or graphite. Examples of nitride ceramics are aluminum nitride, boron nitride, silicon nitride, silicon aluminum oxide nitride and titanium nitride. Examples of carbide ceramics are silicon carbide or boron carbide. By way of example, oxide ceramics may be ceramic materials based on titanium dioxide with or without other oxides, or ceramic materials having a high aluminum oxide content, or ceramic materials based on beryllium oxide, magnesium oxide, zirconium oxide, aluminum titanate, spinel, mullite or titanium oxide.

According to one embodiment, the protective element may consist of a protective body which can be fastened to the oxygen blowing lance such that it can be removed and exchanged. According to another embodiment, the protective element may consist of a carrier structure which bears one or more protective bodies, wherein the protective element can be fastened to the oxygen blowing lance via the carrier structure or protective bodies such that it can be removed and exchanged. The use of a carrier structure makes it easier to produce a protective element of a desired shape. If the protective element is connected to the oxygen lance via the carrier structure, the mechanical loading of the protective bodies is reduced, since these do not have to bear their own weight.

According to one embodiment, the protective element has a shell-like design, i.e. it has a base surface surrounded by side walls. According to a preferred embodiment, the protective element has the shape of a shell, the side walls of which consist of rings stacked one on top of another and the base surface of which consists of a plate. Such an embodiment is easier to produce than a shell produced from one piece. In addition, it has the advantage that damage to a ring propagates less readily into adjacent regions of the protective element than in the case of a shell produced from one piece.

An intermediate space is present between the protective element and the lance head end of the oxygen blowing lance.

Passages, through which the oxygen outlet nozzles are routed from the shell outward, are present in the protective element. The passages are dimensioned such that a gap remains between the oxygen outlet nozzle and the protective element.

Furthermore, openings are present in the protective element and pass through it. Said openings connect the intermediate space between the protective element and the lance head end of the oxygen blowing lance to the space surrounding the oxygen blowing lance.

At least one protective gas line issuing into the intermediate space between the protective element and the lance head end of the oxygen blowing lance is present. This makes it possible to introduce protective gas into said intermediate space.

Protective gas introduced into the intermediate space can flow into the space surrounding the oxygen blowing lance through the gaps between the protective element and the oxygen outlet nozzles and also through the openings which pass through the protective element.

The protective gas line is preferably routed at least partially within the gap between the outer lance tube and the main oxygen tube. It is thereby protected against mechanical, thermal and chemical loading and wearing by the outer lance tube.

The process according to the invention for operating the oxygen blowing lance according to the invention for the production of steel having a protective element is characterized in that protective gas is introduced from the protective gas line into the intermediate space between the cover shell and the protective element and is routed from said intermediate space outward through the gaps between the oxygen outlet nozzles and the protective element and also through the openings in the protective element.

Any chemically inert gas can be used as the protective gas, for example nitrogen or noble gases. It is preferable to use argon, nitrogen or helium.

The protective gas which flows out of the openings and gaps protects both the protective element and the oxygen outlet nozzles against thermal, chemical and mechanical loading and reduces the wearing thereof. These streams of protective gas directed to the outside prevent hot surrounding gases and particles carried along thereby from being able to penetrate to the outer surface of the protective element, and hinder the transmission of heat and mechanical and chemical attacks on the protective element. In this case, the term “outside” is to be understood as meaning that side of the protective element which faces toward the steel melt.

Since the protective gas surrounds the material of the protective element with a chemically inert layer of gas, it is possible to use those materials for the protective element or protective bodies which, owing to their sensitivity to oxidation, would not be usable under the conditions prevailing during the production of steel. By way of example, it is therefore possible to utilize the favorable properties of nitride and carbide ceramics, such as for example silicon nitride, or of graphite with respect to resistance to temperature, temperature fluctuations and also chemical and mechanical attacks for the protective element or protective bodies.

It is known that a negative pressure, which results in the intake of hot, possibly particle-laden surrounding gases, is produced during the operation of oxygen blowing lances by the oxygen flowing out of oxygen outlet nozzles at a high velocity. During the operation of the oxygen blowing lance according to the invention, however, the stream of oxygen is enveloped by a stream of protective gas, which flows outward from the gap between the oxygen outlet nozzle and the protective element.

The intake of surrounding gases counter to the direction in which said enveloping stream of protective gas flows is thereby made more difficult and thermal, chemical and mechanical wearing brought about by said surrounding gases is thereby reduced.

Streams of protective gas which sweep over the surface of the protective element blow adhering splashes of crude steel and slag away from the surface. Wearing brought about by such deposits is thereby reduced.

The stream of protective gas dissipates heat from the protective element and oxygen outlet nozzles and thereby carries out cooling. The gap between the outer lance tube and the main oxygen tube, which contains coolant ducts, is closed at the lance head, i.e. the coolant ducts are not routed further in the protective element. The risk of leakage brought about by wearing of the protective element is therefore reduced.

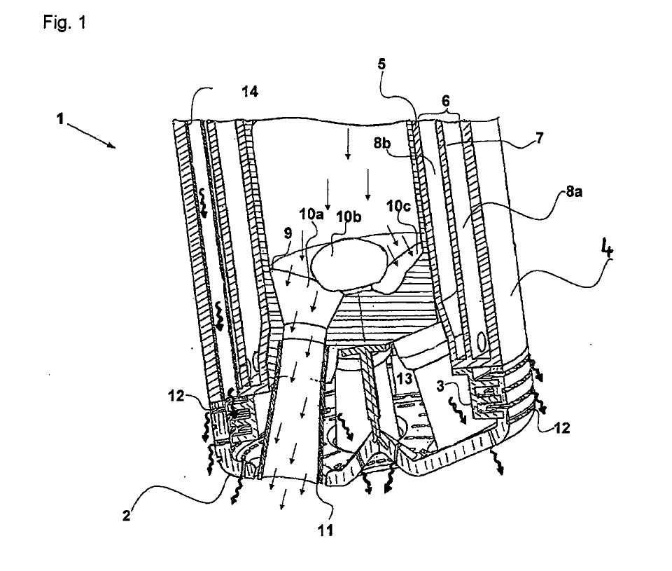

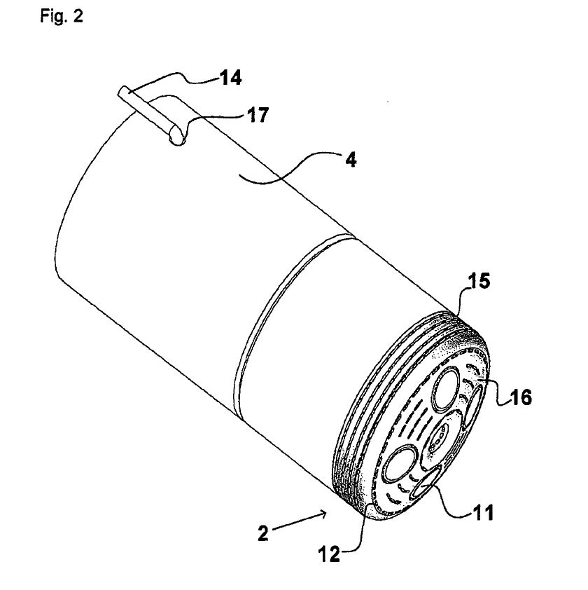

The invention is explained with reference to the attached exemplary and schematic figures, FIGS. 1 and 2, and the following description.

FIG. 1 shows a longitudinal section through the lance head end portion of an operational oxygen blowing lance according to the invention having a protective element.

FIG. 2 shows a perspective view of the lance head end portion of an oxygen blowing lance according to the invention having a protective element.

FIG. 1 shows an oxygen blowing lance 1, the lance head end of which is provided with a protective element consisting of a protective body 2 and a carrier structure 3. A gap 6 is formed between the outer lance tube 4 and the main oxygen tube 5 and is closed at the lance head. Said gap 6 is divided by a dividing tube 7 into two coolant ducts 8a and 8b, which are connected to one another at the lance head by openings in the dividing tube 7. The connection between the coolant ducts 8a and 8b and a cooling water feed line and cooling water discharge line is not shown. The flow of cooling water through the coolant ducts 8a and 8b reduces the thermal loading of the oxygen blowing lance during operation. The end of the main oxygen tube 5 at the lance head is provided with a cover shell 9 which covers the entire end of the main oxygen tube 5. The cover shell has a plurality of outlets 10a and 10b and 10c, into each of which an oxygen outlet nozzle 11 is screwed. The protective element covers the lance head end of the oxygen blowing lance 1. The protective element is fastened to the oxygen lance via the carrier structure 3 by means of a quick-release catch. The oxygen outlet nozzles 11 are routed outward through passages in the protective body 2. In this case, a gap remains between the oxygen outlet nozzles 11 and the protective body 2. Openings 12 pass through the protective body 2. An intermediate space 13 is present between the protective body 2 and the lance head end of the oxygen blowing lance 1. A protective gas line 14 issues into said intermediate space 13 and leads to the intermediate space 13 within the gap 6 between the outer lance tube and the main oxygen tube. During operation of the oxygen blowing lance 1, oxygen (indicated by straight arrows) flows outward from the main oxygen tube 4 through the outlets 10 and the oxygen outlet nozzles 11. At the same time, protective gas (indicated by wavy arrows) flows from the protective gas line 14 into the intermediate space 13. The protective gas flows outward from the intermediate space 13 through the gaps between the oxygen outlet nozzles 11 and the protective body 2. In this case, the stream of oxygen leaving the oxygen outlet nozzles 11 is enveloped by the protective gas which flows out. Furthermore, the protective gas flows outward from the intermediate space 13 through the openings 12 and, after it has left said openings, sweeps over the surface of the protective body 2.

For the oxygen blowing lance shown in FIG. 1, FIG. 2 shows the outer lance tube 4 and the adjoining protective body 2 of the protective element. The side walls of the shell-like protective body 2 consist of rings 15 stacked one on top of another, and the base surface consists of a plate 16. Oxygen outlet nozzles 11 are routed outward through passages in the protective body 2, a gap remaining in each case between the oxygen outlet nozzle and the protective body 2. The protective body 2 has openings 12. A protective gas line 14, which runs partially outside the oxygen blowing lance, is routed through an insertion opening 17 into the gap between the outer lance tube 4 and the main oxygen tube.

Compared to an oxygen blowing lance having a protective cap as in the prior art document DE3122178A1, the oxygen blowing lance according to the invention having a protective element has the advantage that the protective element and the oxygen outlet nozzles are protected by the protective gas against mechanical, thermal and chemical loading and wearing and therefore have to be exchanged less often. If exchange is necessary, both the protective element and the oxygen outlet nozzles can be replaced by new components without any outlay owing to quick-release catches.

### LIST OF REFERENCE SYMBOLS

Oxygen blowing lance 1

Protective body 2

Carrier structure 3

Outer lance tube 4

Main oxygen tube 5

Gap 6

Dividing tube 7

Coolant ducts 8a, 8b

Cover shell 9

Outlets 10a, 10b, 10c

Oxygen outlet nozzle 11

Openings 12

Intermediate space 13

Protective gas line 14

Ring 15

Plate 16

Insertion opening 17

1. An oxygen blowing lance for the production of steel, the lance comprising:
a lance head end at an end of the lance;
an outer lance tube and a main oxygen tube having a lance head end at the lance head end of the lance and positioned within the outer lance tube;
a gap is present between the outer lance tube and the main oxygen tube, the gap being closed at the lance head and including one or more coolant ducts;
the lance head end of the oxygen blowing lance comprising a protective element covering the lance head end of the oxygen blowing lance and fastened to the oxygen blowing lance such that the protective element is removable and exchangeable;
an intermediate space is present between the lance head end of the oxygen blowing lance and the protective element;
the lance head end of the main oxygen tube comprises a cover shell having one or more outlets;
an oxygen outlet nozzle fastened to each outlet such that each oxygen outlet nozzle is removable and exchangeable;
passages configured to route the oxygen outlet nozzles from the shell outward, the passages positioned in the protective element, the passages are each dimensioned such that a gap remains between the oxygen outlet nozzle and the protective element;
openings are present in the protective element; and
at least one protective gas line issuing into the intermediate space between the lance head end of the oxygen blowing lance and the protective element.

2. The oxygen blowing lance as claimed in claim 1, wherein the oxygen outlet nozzles and/or the protective element are fastened by quick-release catches.

3. The oxygen blowing lance as claimed in claim 2, wherein the protective gas line is routed at least partially within the gap between the outer lance tube and the main oxygen tube.

4. A method of operating an oxygen blowing lance as claimed in claim 1, the method comprising:
introducing protective gas from the protective gas line into the intermediate space between the cover shell and the protective element; and
routing the protective element from the intermediate space outward through the gaps between the oxygen outlet nozzles and the protective element, and through the openings in the protective element.

5. The oxygen blowing lance as claimed in claim 1, wherein the protective gas line is routed at least partially within the gap between the outer lance tube and the main oxygen tube.
